(19) United States
(12) Patent Application Publication
(10) Pub. No.: US 2018/0226101 A1
(43) Pub. Date: Aug. 9, 2018

(54) METHODS AND SYSTEMS FOR INTERACTIVE MULTIMEDIA CREATION

(71) Applicant: Plugg Music Inc., New York, NY (US)

(72) Inventors: Peter TAYLOR, New York, NY (US); Sean COKER, New York, NY (US)

(21) Appl. No.: 15/944,319

(22) Filed: Apr. 3, 2018

Related U.S. Application Data
(63) Continuation of application No. PCT/US2016/056298, filed on Oct. 10, 2016.
(60) Provisional application No. 62/239,796, filed on Oct. 9, 2015.

(51) Int. Cl. G11B 27/02; G06F 17/30; G06F 3/0488; G06F 3/0484

(52) U.S. Cl. CPC G11B 27/02; G06F 3/04847; G06F 3/0488; G06F 17/3002

(57) ABSTRACT

A multimedia creation tool which determines the time structure of a sequence of media and text files using user inputted timestamps. A sequence of text strings are associated with a sequence of media files using timestamps input manually and with user commands. Adjacent text strings in the sequence can be separated any symbol that can be read by a processor. The timestamps are created in response to commands from users, such as touches on a touch screen or hitting the space bar on a keyboard. Each time a user enters a command, a text string can be inserted into the multimedia file at a temporal location based on the timing of the command. A user can associate a particular media file with a particular text string, so both can be inserted into the multimedia file at the same time. This tool can significantly reduce the time and cost of creating a multimedia file.

### CROSS-REFERENCES TO RELATED APPLICATIONS

This application claims to International Application No. PCT/US2016/056298, filed Oct. 10, 2016, and entitled “METHODS AND SYSTEMS FOR INTERACTIVE MULTIMEDIA CREATION,” which in turn claims the priority benefit of U.S. Application No. 62/239,796, filed Oct. 9, 2015, and entitled “INTERACTIVE MULTIMEDIA CREATION TOOL.” Each of these applications is hereby incorporated herein by reference in its entirety.

### BACKGROUND

Social video is a common phrase used to describe video that is created to share information on social media sites, such as Facebook, YouTube, Instagram, Snapchat, Vine and other social media outlets.

Social videos are often text-driven, since more and more people now watch videos silently without headphones. In the past, software such as Final Cut Pro, Avid, Sony Vegas, Adobe Premiere and iMovie can be used to create video for social media.

Mobile video editors have also been used to create social video on a mobile device. However, due to the amount of intricate editing to insert, edit, and stylize a sequence of text, video, and pictures, the greater majority of the content creators have not had the time or resources to create videos for social media on a regular basis.

Due to the giant growth in video uploads on the web in 2016, content creators (businesses, bloggers, entertainers, artists, athletes, journalists) have been searching for a faster, more user friendly way to create text-driven videos for social media.

### SUMMARY

Methods and systems described herein generally relate to an interactive multimedia creation tool. The methods and systems described herein more particularly relate to an interactive multimedia creation tool for the creation of customizable audio visual displays and representations.

In one example, a system for generating a multimedia file includes a player, at least one user input device, a memory to store processor-executable instructions, and a processor operably coupled to the player, the at least one user input device, and the memory. Upon execution of the processor-executable instructions, the processor receives one or more media files, each having a time structure, receives a sequence of text strings, and creates a plurality of timestamps within the time structure of the media file(s) in response to user commands entered via the input device while playing the media file on the player. The processor also saves the plurality of timestamps within the memory and associates each text string in the sequence of text strings with a corresponding timestamp in the plurality of timestamps. The processor further renders the multimedia file based at least in part on the media file(s), the timestamps, and the sequence of text strings.

In another example, a method for generating a multimedia file includes receiving one or more media files, each having a time structure, creating a plurality of timestamps within the time structure of the media file(s) based on a plurality of user commands provided by a user with at least one input device, and saving the plurality of timestamps within a memory. The method also includes receiving a sequence of text strings and associating each text string in the sequence of text strings with a corresponding timestamp in the plurality of timestamps. The method further includes rendering the multimedia file based at least in part on the media file(s), the timestamps, and the sequence of text strings.

In yet another example, a system for generating a multimedia file includes a touch screen, a memory to store processor-executable instructions, and a processor operably coupled to the touch screen and the memory. Upon execution of the processor-executable instructions, the processor receives a music file including a video manifestation and an audio file and the music file having a time structure. The processor also creates a plurality of timestamps within the time structure of the music file in response to touches on the touch screen from a user and saves the plurality of timestamps within the memory. The processor further receives a sequence of text strings including a lyric of the music file. Adjacent text strings in the sequence of text strings are separated by a separator character. The processor also associates each text string in the sequence of text strings with a corresponding timestamp in the plurality of timestamps based at least in part on a location of each text string in the plurality of text strings and renders the multimedia file based at least in part on the music file, the plurality of timestamps, and the sequence of text strings. The processor also displays the multimedia file with the sequence of text strings overlaid on the video manifestation of the music file and synchronized with the audio file of the music file.

In yet another example, a system for generating a multimedia file includes a display, at least one user input device, a memory to store processor-executable instructions, and a processor operably coupled to the display, the at least one user input device, and the memory. Upon execution of the processor-executable instructions, the processor receives a video file having a time structure and receives a sequence of text strings. The processor also creates a timestamp within the time structure of the video file in response to a user command entered via the at least one input device while displaying, on the display, the video file and at least one text string in the sequence of text strings and associates the at least one text string with the timestamp.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTIONS OF THE FIGURES

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 shows a schematic of a system for creating multimedia file.

FIG. 2A illustrates a method for creating multimedia file.

FIG. 2B illustrates a method for creating multimedia file from video, text, and audio files.

FIG. 2C illustrates a method for pinning an article of text with a video file.

FIG. 2D illustrates a method for automatically merging a multimedia file using timestamp data collected from user commands.

FIG. 3 illustrates a method of creating multimedia files with automatic pairing of a video file with user provided timestamps.

FIG. 4 illustrates a method of automatically resizing text in videos.

FIGS. 5A-5C show user interfaces of an interactive multimedia creation tool on a user's mobile devices.

FIG. 6 shows a user interface of an interactive multimedia creation tool including features to facilitate video creation.

FIG. 7 shows a user interface of an interactive multimedia creation tool including components for adjusting visual effects.

FIG. 8 shows a visual media creation tool component of an interactive multimedia creation tool.

FIG. 9 shows a user interface of an interactive multimedia creation tool including a navigation tool.

FIG. 10 shows a visual media output using interactive multimedia creation tools.

FIG. 11 shows a visual media creation tool component of an interactive multimedia creation tool for real-time alteration of visual effects.

FIG. 12 shows a user interface for sharing a visual media output using the interactive multimedia creation tool.

### DETAILED DESCRIPTION

Interactive Multimedia Creation Tools

Systems and methods described above allow users (e.g., musicians, DJ's, podcasters and filmmakers) to create lyric videos and captions within minutes on a modest budget, without a professional animator or editor. These systems and methods can be configured as a user-friendly tool (also referred to as an interface) for users without professional experiences in video creation. Users can use this interactive multimedia creation tool to create a lyric video in real-time within about 3-5 minutes.

In one example, the process of lyric video creation can include the following steps. First, a user logs in to a remote server, where systems and methods described above are implemented, and chooses to upload a song from a user's device (e.g., personal computer or tablet). This step can take about 30 seconds. The user also pastes the lyrics of the song into a lyrics box provided by the server through a user interface. This step can take about 10 seconds. The user further chooses a pre-recorded background video or uploads a background video of his own. This step can take about 30 seconds.

Then, the user chooses the speed of the audio playback when recording. The speed can be either 25%, 50%, or 75% of the original speed. This selection of speed can take about 5 seconds. In next step, the user presses a record button, provided by the server through the user interface. The user also taps his user device, such as an Apple Trackpad or spacebar, once for every lyric or hyphenated syllable in the song. This process can take about 2 minutes to about 4 minutes.

When finished recording, the song plays back automatically and the user can customize the theme, font and effects. This step can take about 30 seconds. At this point, the lyric video is completed and can be saved to the computer or shared to the web once finished rendering. This step can take about 1 minute to about 3 minutes.

The user can enter text (lyrics, etc.) by copying and pasting it into the lyric box or other data entry field. The user can also enter text using an auto-voice recognition tool, such as Google translate or another web-based auto-voice recognition tool. This allows a musician to skip the recording process altogether. With this text translation, the Interactive Multimedia Creation Tool can link the text with the voice recording and music, automatically within seconds. This feature also allows musicians and DJ's to create lyric videos and captions within seconds by importing the voice recording and music separately.

Technical elements of the Interactive Multimedia Creation Tool can capture the timecode data for each word or syllable, process (render) the video, and export the finalized video to a video sharing platform. These technical elements may include:

Framerate: The text playback can be about 20 fps to about 100 fps (frames per second) (e.g., about 20 fps, about 30 fps, about 40 fps, about 50 fps, about 60 fps, about 70 fps, about 80 fps, about 90 fps, or about 100 fps, including any values and sub ranges in between). It may be later rendered at 30 fps (i.e. cinema quality).

Resolution: The resolution output multimedia file can be about 720×1280 (i.e., high definition video quality). The resolution can also be any other suitable resolution level provided by, for example, the user, the player used to play the multimedia file, or the desired size of the multimedia file.

Background: The background(s) can be chosen by the user. By default, a video of a simulation can be looped. The users can upload their own videos, which can be temporarily stored on a server, until rendered and shared to an online video platform.

Fonts: The user can select a font from a suitable font application programming interface (API), such as the Google Font API. Custom fonts can also be available to users.

Effects: All of Google's Web Font effects can be applied to the text by the user, and rendered in the backend.

Rendering: Rendering can be defined as a process of combining still pictures, video clips, audio clips, text strings, and other elements into a single digital video frame (also referred to as the final product). The process of video rendering can start with the assembly of video elements and the basic effects to enhance the final product. A pre-rendering method can be carried out before the main rendering process is done. In this method, an outline can be drawn and models can be arranged to align with the video elements. Audio elements can also be mixed in. Gradually, the models and outlines are improved on every pass until the video elements, audio elements and special effects are aligned correctly. Software can be used to determine the shading, textures, and dimensions of the video elements and the effects. This step can give all the elements a united look and feel, mixing them to achieve one video frame. In one example, each individual frame can be stitched together using an HTML5 animation element, such as Canvas, before being exported to a video platform.

Scene Changes: In order to change a video background at a certain point in a song, a user can enter a short code (e.g., <;>) into the text box at the point where the change is desired to occur.

Syllable Recognition: In order for the function to record a syllable with each tap, rather than a word, a user can enter a hyphen (-) (or any other symbol appropriate) in between each syllable.

Time Stretch: An HTML5 time-stretching API can be used to allow the user to reduce the speed of the audio when recording.

Video Annotations: A user can choose to use the function to record captions for a video. To do this, a user can copy their script into the text box, uploads their video file, and records the captions in real time. The user can then export the captions as a .txt file and upload the text file to YouTube.

Exporting: A user can login to Facebook, YouTube, Vimeo, or any other suitable social media or website from the tool, which allows instant sharing to the video platforms without having to export the file to disk.

Applications of Interactive Multimedia Creation Tools

Interactive Multimedia Creation Tools can be used by a musician to record lyric videos for each of the songs on their album so they can grow their fan base on YouTube and Facebook, among others. They can also be used to create instant captions for scripted television series, web series, or live events to create videos. A fan of a musician may use an Interactive Multimedia Creation Tool to create a unique lyric video for their favorite hits, and then upload to YouTube or another suitable platform. A DJ can use an Interactive Multimedia Creation Tool to create instant Karaoke videos for listeners to sing along with.

The Interactive Multimedia Creation Tool can also be used to create captions (subtitles) for a scripted video. In order to create captions for a video, a director typically employs a graphical editor like www.CaptionGenerator.com. The editor normally has time codes to be entered manually for each word in order to line the text up with audio. This process can be tedious and is rarely used by directors on a tight time frame or a low budget. As a result, the deaf community is generally unable to enjoy the majority of video entertainment on the web. The Interactive Multimedia Creation Tool makes it possible for all video creators to create subtitles in real time using the same process as a lyric video.

In one example, the Interactive Multimedia Creation Tool can be used to generate a variety of different content outputs, using several different types of content inputs, including, but not limited to, content outputs that incorporate both visual and audio outputs and visual and audio inputs. In another example, the Multimedia Creation Tool may be used to create subtitle for scripted series, to create audio and visual media content for webisodes, narrative videos and speeches, among others. Additionally, the Interactive Multimedia Creation Tool can also be used to combine physical content with audio or visual media content. For example, the Interactive Multimedia Creation tool may be used to generate narrative audio content to correspond to a physical display, such as a play or demonstration.

Overview

To reduce the time and cost to create a multimedia file (e.g., a lyric video), systems and methods described herein employ a technology to associate a sequence of text strings (also referred to as texts or articles of text) with timestamps in a media file (e.g., an audio file or a video file). Adjacent text strings in the sequence can be separated by a hyphen or any other symbol that can be read by a processor. The timestamps are created in response to commands from users, such as touches on a touch screen or hitting the space bar on a keyboard. In this manner, each time a user enters a command, a text string can be inserted into the media file at a temporal location based on the timing of the command. Therefore, the time and cost of creating a multimedia file can be significantly reduced. In addition, the user can create multimedia files without taking classes, acquiring a degree, or other costly training and without expensive editing software.

Systems and methods disclosed herein allow a user to create visual representations of an audio output. The audio output may include, but is not limited to, music. Visual representations of the audio output may be displayed using a variety of different types of displays such as, but not limited to, a computer screen, smartphone, smartwatch, or tablet device. For example, a user can use this technology to conveniently overlay animated text on top of video, in sequence with a pre-recorded lyrical song or narrative, or to incorporate a number of different media forms into content incorporating several different content inputs with several different content outputs. The various content inputs and outputs can include a lyric video, scripted show, interactive web series, speech, narrative, or any other form of media content known in the art. This technology also allows users to combine multiple forms of media into a single output, or multiple outputs, such as allowing an artist to record animated text along with a video in real-time, without any additional software.

Systems and methods described herein can be provided to and accessed by a user via a variety of different methods. For example, a user can use a mobile app installed on a smartphone to create a multimedia file. In another example, a hosted software service can be used for the user to create multimedia files. In yet another example, the systems and methods can be accessed on an internet website, where a user can create a personalized account for multimedia creation.

Systems for Creating Multimedia Files

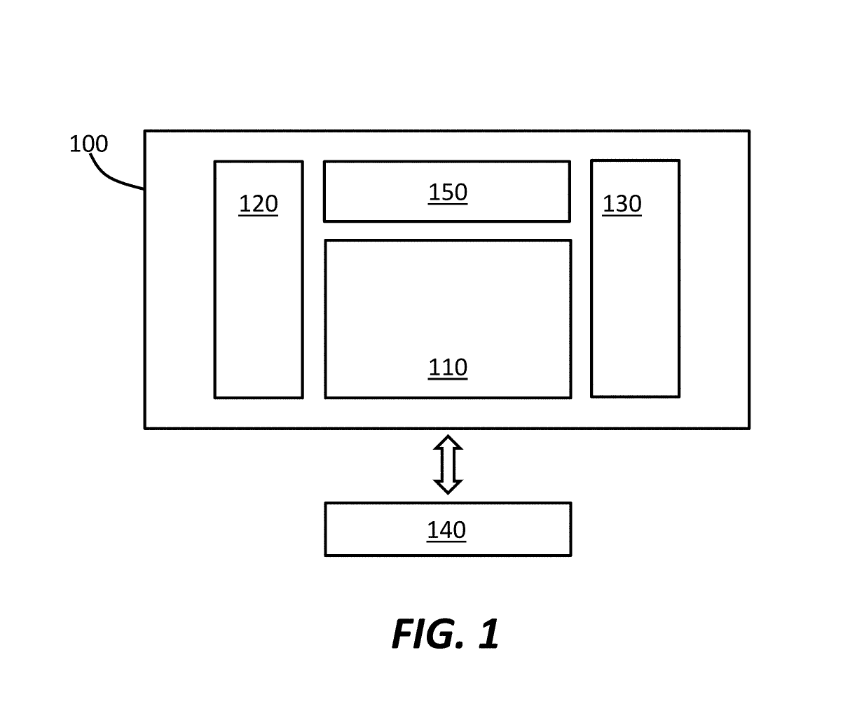

FIG. 1 shows a schematic of a system 100 for creating multimedia files. The system 100 can be implemented as a suitably programmed computer, tablet, smartphone, or other computing device. The system 100 includes a user input device 110, such as a keyboard, mouse, or touchscreen, to receive user inputs 140, which can include, for example, input media files (e.g., music file, video file without captions, etc.), user commands (e.g., indication of timing locations for inserting lyrics or captions), and text to be inserted into the media file. The system 100 also includes a media player 150, such as a display, speaker, or both, to play the media file to facilitate the user to enter the user commands. The system 100 further includes a memory 120 for data storage and a processor 130. The data stored in the memory 120 can include, for example, processor-executable instructions that cause the processor 130 to generate the multimedia files. The memory 120 can also be used to store text strings to be inserted into the medial file.

The instructions stored in the memory 120 instruct the processor 130 to perform one or more steps in methods for creating multimedia files. In one step, the processor 130 controls the system 100 to receive one or more media files, such as video or image files. The media file(s) may have or be characterized by an explicit or implicit time structure, or linear temporal progression. In one example, the time structure can be represented by timing locations. For example, a video can have a time duration of about 1 minute and the time structure can be represented by a progression of time from 0 to 1 minute. In another example, the time structure can be represented by the number of frame in a sequence of frames, such as a video file.

In one example, the processor 130 can control a communication interface (not shown in FIG. 1), such as an interest or other network interface, to receive the media file provided by another device. In another example, the processor 130 can control the system 100 to retrieve the media file stored in the memory 120. In yet another example, the system 100 can include a recording device (not shown in FIG. 1) to capture the media file. For example, the system 100 can include an audio recorder (e.g., a microphone) to record audio files and/or a video recorder (e.g., a camera) to record a video file.

In one example, the media file can include an audio file, such as a song, a narrative, a lecture, or any other types of audio file known in the art. In another example, the media file can include a video file (also referred to as a video clip). The video file can include its own audio file. Alternatively, the video file can be silent.

The processor 130 creates a series of timestamps, stored within data files, which are associated with the media file in response to user commands from the user input device 110. At the same time, the media player 150 plays the media file to facilitate the user to conveniently pinpoint the location to enter a text string. Text string(s) can also be displayed for the user. In one example, the display of the text string can be in response to the user command. For example, each time a user enters a command, one text string in the sequence of text strings is displayed on a display. The display can be part of the player 150. In another example, the media player 150 can always display a text string and the command from the user causes the media player 150 to display the next string in the sequence of text strings. For example, when a user starts the video creation, the media player 150 displays the first text string in the sequence until the user enters a user command. In response to the user command, the player 150 displays the second text string in the sequence of text strings. The processor 130 can also associate the first text string with the timestamp created in response to the first user command. In yet another example, one user command can be used to indicate the end of one text string and the start of the next text string.

In one example, the user input device 110 includes a touch screen, and the processor 130 can create a timestamp each time a user touches the touch screen. The timestamp includes the timing information of the user's touch with respect to the time structure of the media file. For example, if the media file has a duration of 3 minutes, the timing information can specify at which time within this three minutes (e.g., at 1 minute, 15 seconds) the user touches the screen.

The timestamp can also document the number of fingers that are used to tap the screen. The text size and other style elements can change accordingly, depending on this number of fingers. For example, a user can change the font size using two fingers to tap the screen, or change the style elements using three fingers.

In another example, the user input device 110 includes a keyboard, and the processor 130 creates a timestamp each time a user hits a pre-determined key on the keyboard. The pre-determined key can be, for example, the space bar, or a user-defined key (e.g., “L” key for lyrics, “S” key for subtitle, etc.). The pre-determined key can also include a combination of keys, such as Ctrl+Shift+L or any other combination.

In yet another example, the user input device 110 can include a voice recognition device to receive user commands from the user by recognizing vocal commands. The vocal commands can include a pre-determined word, such as “lyrics,” “insert,” “caption,” or any other appropriate word. Each time the voice recognition device recognizes that the user says this pre-determined word, the processor 130 creates one timestamp.

In yet another example, the user input device 110 can include a gesture recognition device to recognize a specified gesture made by the user. For example, the specified gesture can be a waving of a hand, a nod of the user's head, a link of the user's eye(s), or any other gestures that are appropriate. Each time the gesture recognition device recognizes the specified gesture, the processor 130 creates a timestamp. In yet another example, the user input device 110 can include a combination of the input devices described above.

The processor 130 controls the memory 120 to store the timestamps created in response to user commands 140. The processor 130 also controls the system 100 to receive a sequence of text strings. In one example, the text strings include lyrics of a music file. In another example, the text strings include captions or subtitles of a video file. In yet another example, the text strings include transcript of a narrative or a lecture. In yet another example, the text strings include the transcripts of off screen sound for a video file. In yet another example, the text strings can include any other text to be inserted into the media file.

In one example, each text string can be inserted into one frame of the generated multimedia file. In another example, each text string can be inserted into several frames of the generated multimedia file. In one example, each frame of the generated multimedia file can include one text string. In another example, each frame of the generated multimedia file can include more than one text string.

To facilitate inserting the desired number of text string(s) into each frame, adjacent text strings in the sequence of text strings can be separated by separator character. This may be a tab, carriage return, or other space. In one example, the signal can include a hyphen. In another example, the signal can include a semicolon (i.e. “;”). In yet another example, the signal can include a colon (i.e. “:”). In yet another example, more than one type of signal can be used in the sequence of text strings.

In a fifth step, the processor 130 associates each text string in the sequence of text strings with a timestamp in the multiple timestamps created in response to the user commands. In other words, each text string is matched to a timestamp, which includes the timing information of the user command that prompts the generation of this timestamp. In this manner, the processor 130 can insert the text string into the media file at the timing location where the user makes the command.

In one example, the user can input the sequence of text strings to the system 100 before creating the timestamps. In another example, the user can first make the user commands to create the timestamps and then input the text strings. In yet another example, the user can input the text strings and users commands in a real-time manner. For example, each time the user touches a touch screen, the processor 130 can create a timestamp and also prompt the user to input a text string to be inserted at this temporal location of the media file.

The association between the text string and the timestamp can be based on the location of the text string in the sequence of the text strings. For example, the first text string in the sequence of text strings can be associated with the timestamp created at the time of the first user command. Similarly, the nth text string in the sequence of text strings can be associated with the nth timestamp created at the time of the nth user command, where n is a positive integer.

The processor 130 stores the timestamps, in the memory, the sequence of text strings, as well as the association between the timestamps and the text strings. The processor 130 renders a multimedia file by stitching together frames using Ffmpeg and Node Canvas or other suitable technology. The rendering is based on the media file(s), the timestamps, and the sequence of text strings. For example, the multimedia file can include a video clip having multiple frames and one or more of the frames includes a caption (or subtitle). In another example, the multimedia file can be rendered to include music with a background video and lyrics displayed on the background video.

In one example, the system 100 can be implemented on a user device, such as a smartphone, a tablet, a personal computer, or any other device known in the art. In another example, the system 100 can be implemented on a remote server and the user can access to the system 100 using a user device via Internet connection or any other connection known in the art. In this case, the user can send user commands 140, the media file, and the text strings to the server, which then consolidates this data and renders the multimedia file.

The various steps described above can be performed in any order, not necessarily in the order as described. For example, the capturing of user commands can be carried out after receiving the sequence of text strings. The saving of the sequence of text strings can also be performed before the receiving the user commands.

Methods of Creating Multimedia Files

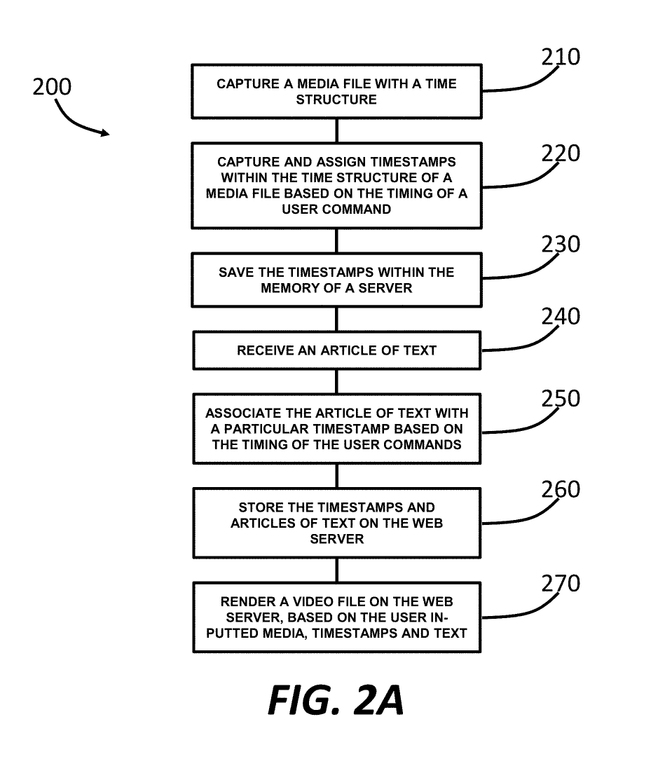

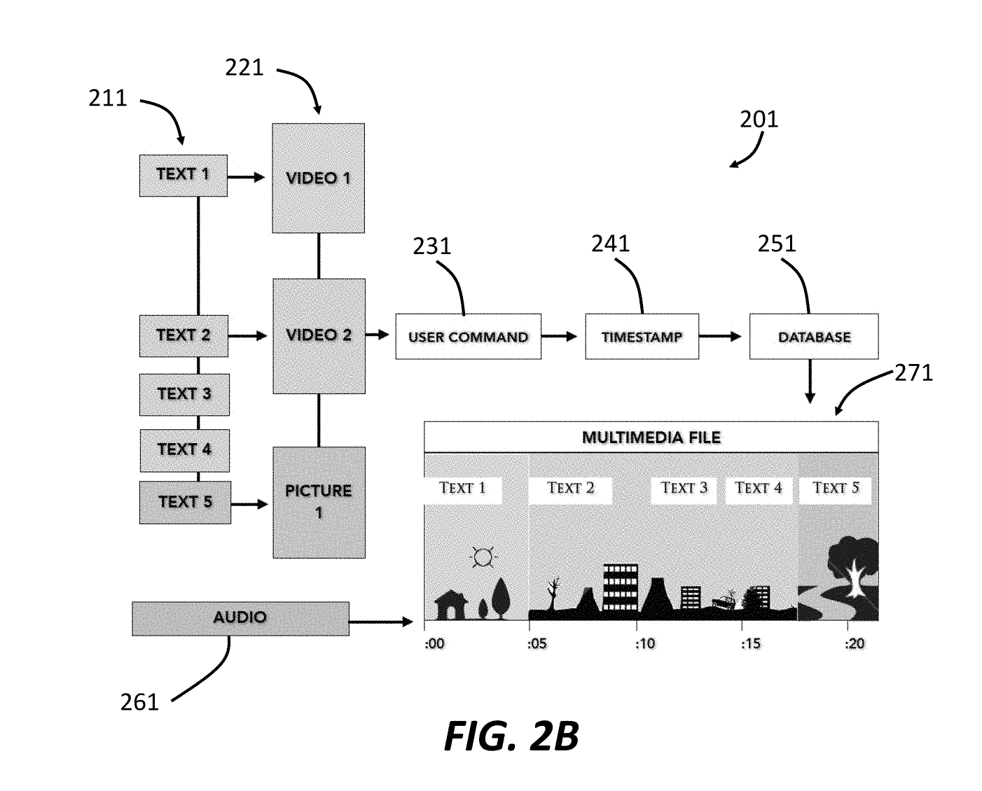

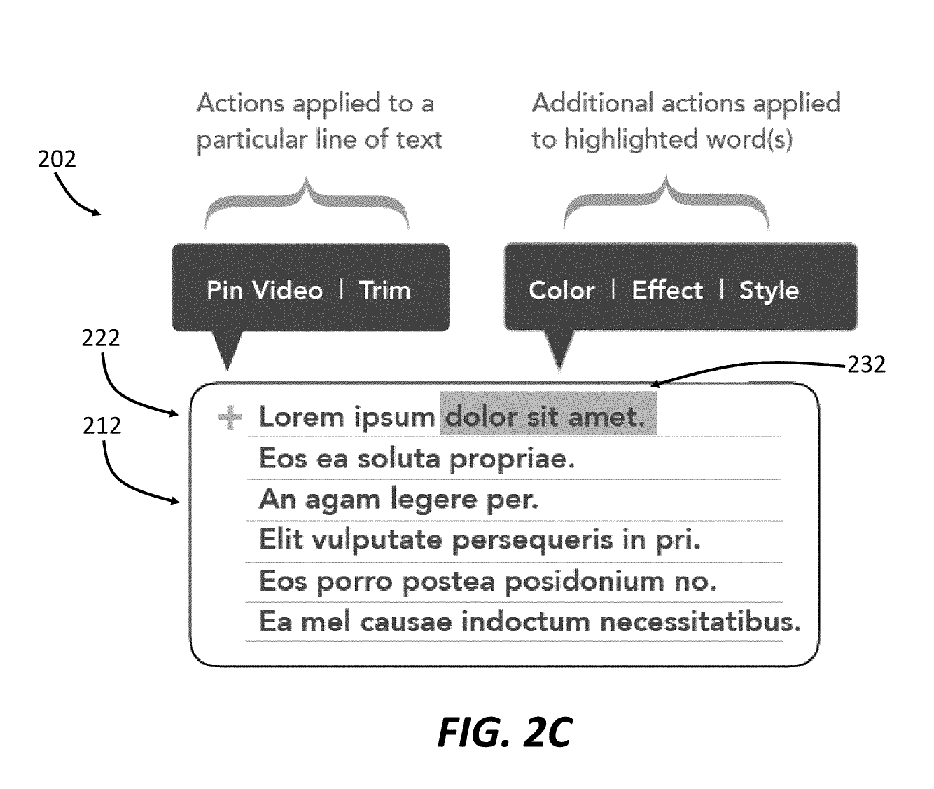

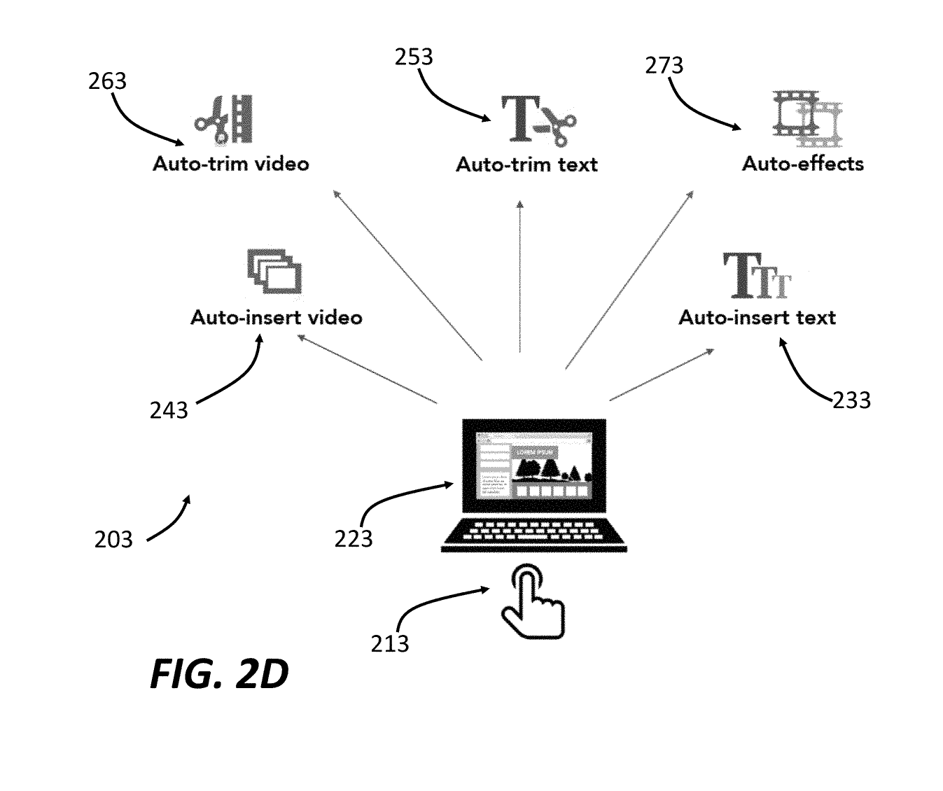

FIG. 2A illustrates a method 200 of creating multimedia files, e.g., using the system 100 shown in FIG. 1. At step 210 of the method 200, a media file having a time structure is captured or received. The media file can be captured by an audio recorder or a video recorder. Alternatively, a user can provide a pre-recorded media file for further processing. The media file is played and the user provides user commands at temporal locations in the media file where one or more words or text characters are to be inserted. At step 220 of the method 200, a processor is used to create and assign timestamps within the time structure of the media file based on the timing of the user commands. The timestamps are saved to a memory, which can be part of a user device or a remote server, as in step 230 of the method 200.

At step 240 of the method 200, the user provides one or more words (also referred to as text strings) to the processor. At step 250, the article of text is associated with a particular timestamp in the multiple timestamps created at step 220. The association can be based on the timing of the user commands. Step 260 of the method 200 includes storing the timestamps and text in the memory and step 270 of the method 200 includes rendering a multimedia file based on the user inputted media file, the timestamps, and the text.

The creation and assignment of timestamps step 220 within the time structure of the media file can be accomplished by having the user enter the user commands by tapping a key on a keyboard or tapping a touch screen as the multimedia file is being created.

When the user starts a recording, the timestamps can be collected on the user's device. These timestamps can be temporarily presented for the user's review by playing the media file with these timestamps. After the user is satisfied with the edits, the user can start the actual rendering process, which sends the collected timestamps to the processor. In one example, the processor can be located on a remote server and the transmission of timestamps can be achieved via a fetch application programming interface (API). In another example, the data can be transmitted (and/or received) by any other suitable client-server communication, such as XML Http Request (XHR) or websockets, among others.

Other than the timestamps collected on the user's device, several other types of data can also be transmitted between the user and a server. For example, any desired effects, chosen fonts, text and video options can also be provided for the user. Similarly, the user can also send any desired effects, chosen fonts, text and video options to the server to render the multimedia file. When the backend receives this data, the server can generate individual video frame images based on the user's request. For example, a user can upload a 30-second video for a song that is 1 minute long, in which case the server can generate 2 loops of the video as the background video in order to fill the time for the song. The server can also extract the individual frames into images using, for example, a library called FFmpeg.

After extracting the frames, the server can draw the user's desired text and effects on the frames in a frame-wise manner. This process can be similar to the way a video is rendered on a user's device using a library called node-canvas. After all frames have been drawn on, the server can stitch them back together using FFmpeg creating the final multimedia file.

Any stylized effects chosen by the user can be drawn to the screen in real-time, frame by frame, based on the desired duration. For example, a user can choose a fade-in effect to occur over the duration of a second, and their screen's refresh rate is 60 Hz, in which case the fade-in effect can go from 0.0 opacity (invisible) to full 1.0 opacity, in approximately 17 frames (1000 ms/60 fps) interpolating each opacity value.

FIG. 2B illustrates method 201 for creating multimedia file from video, text, and audio files. At step 211 of the method 200, a series of text strings (text 1, text 2, . . . , text 5) are entered by the user. At step 221, a series of media files, including video files (video 1 and video 2) and picture file (picture 1), are entered by the user. Each video file is associated with one or more specific text strings. For example, as shown in FIG. 2B, text 1 is associated with video 1. Text 2, text 3, and text 4 are associated with video 2. Text 5 is associated with picture 1.

In one example, the association between the text file and the video file can be based on the content of the text file. For example, text 1 can include words such as “sun” and/or “forest” and video 1 depicting sunshine over a forest can be selected from the video file to be associated with text 1. In another example, the text file and the video file can be displayed on a display. A user can then taps the display (or by any other user command) to pin the current video displayed on the display with the text string displayed also on the display. The method 201 also includes step 231, where the user enters commands. In addition to text files and video/picture files, an audio file is also provided, at step 261.

At step 241, the user creates timestamps, e.g., by tapping a touchscreen or a key on a keyboard. The system captures the time of each command as entered by the user. Each text string is also associated with a timestamp and a multimedia file including the video files, the picture files, and the audio file. At step 251, each timestamp, its associated text string, and its associated multimedia file are saved to a database. At step 271, the audio file is layered with the video files, the picture files, and the text strings so as to render the multimedia file, which can also be made available for downloading. The multimedia file includes the display of two videos (here, video 1 and video 2) and one picture (picture 1). Text 1 is displayed on video 1; text 2, text 3, and text 4 are displayed on video 2; and text 5 is displayed on picture 1 according to the association achieved at step 221. The x axis of the multimedia file includes the time structure of the audio file, which is also synchronized with the display of the video/picture files.

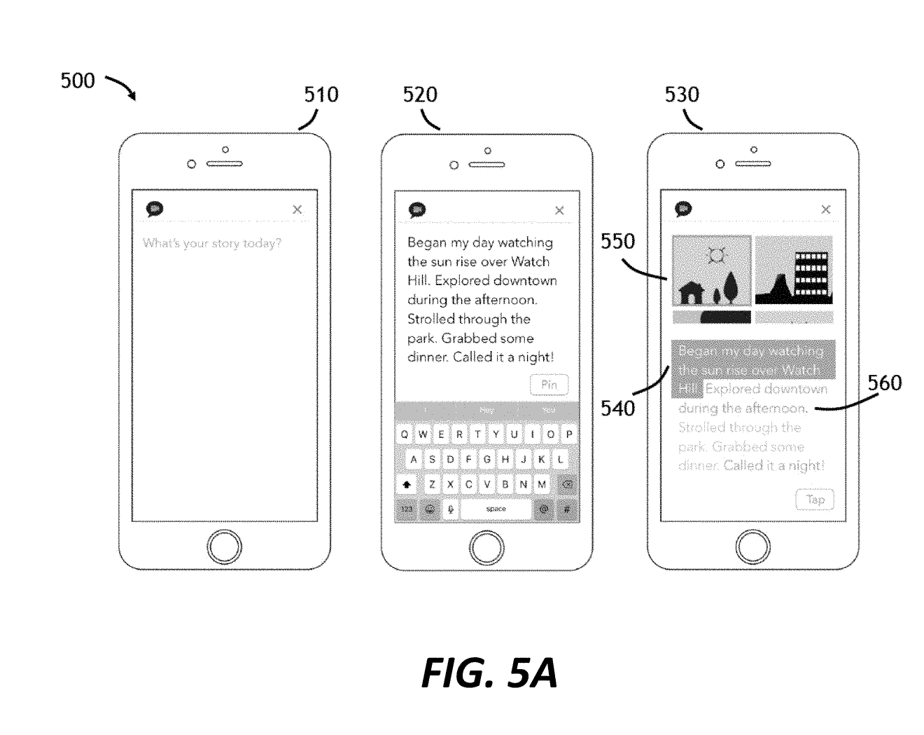

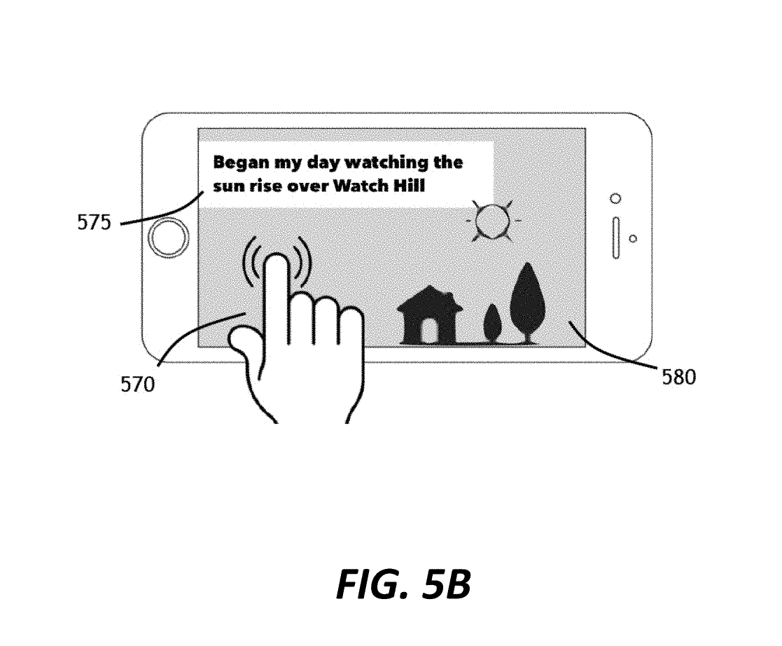

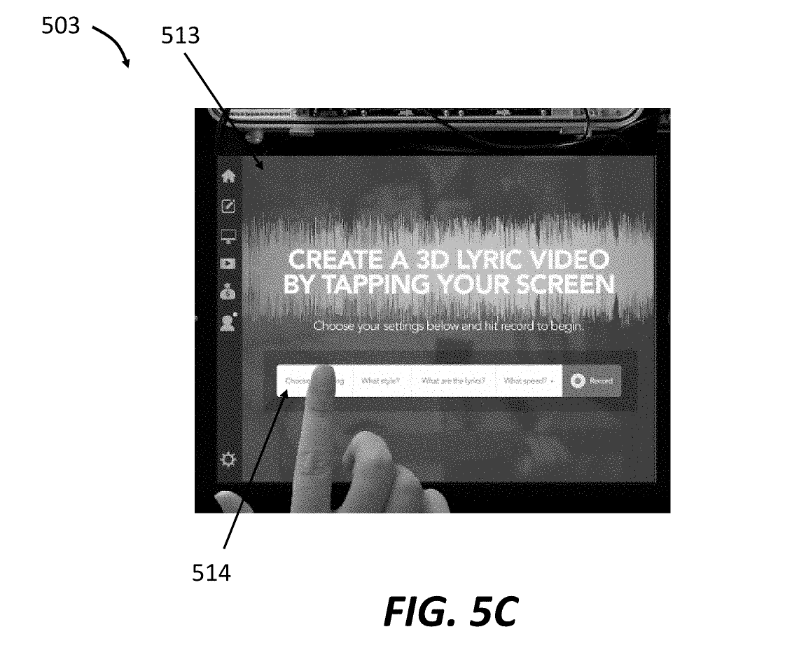

FIG. 2C illustrates a method 202 for pinning a text string to a video file. The method 300 also applies additional effects to highlighted text. At step 212 of the method 202, a user enters text (e.g., speech, lyrics, narrative, or instructions) into a text box. The text box can be provided by a user interface in the multimedia creation tool (see, e.g., FIGS. 5A-12). Each line of the text has a rollover action symbol, which opens up an action window. At step 222, a pin to video action associates a video with the individual line, and a trim action allows a user to manually enter the start and end points of the selected video. At step 232, a user highlights a word, or a group of words. In response, an action window with custom options associated with that selection of words appears. The user can then change the color, effect, and/or style of the selected text.

FIG. 2D illustrates a method 203 for automatically merging a multimedia file using timestamp data collected from user commands. At step 213 of the method 203, a user enters commands into a multimedia creation tool, which can be configured on a computer, a smartphone, a tablet, or any other appropriate device known in the art. The entry of the command can be achieved by tapping the screen or a key on the key board of the tool. At step 223 of the method, timestamps are created to capture the time each command is entered. The user can also enter a series of articles of text, each of which can be associated with each timestamp.

At step 233, the tool automatically inserts text into the multimedia file according to the user inputted command. At step 243, the multimedia file is automatically inserted with article of text, if previously “pinned” by user. At step 253, the tool automatically trims the text according to the duration of its associated timestamp. At step 263, the multimedia file is automatically trimmed based on timestamps. At step 273, the tool merges the text styling, video filters, and transitions and renders the finished multimedia file. In one example, the steps 223 to 273 can be configured to be carried out in response to a single user command provided in step 213.

Automatic Pairing of Video Clips with Timestamps

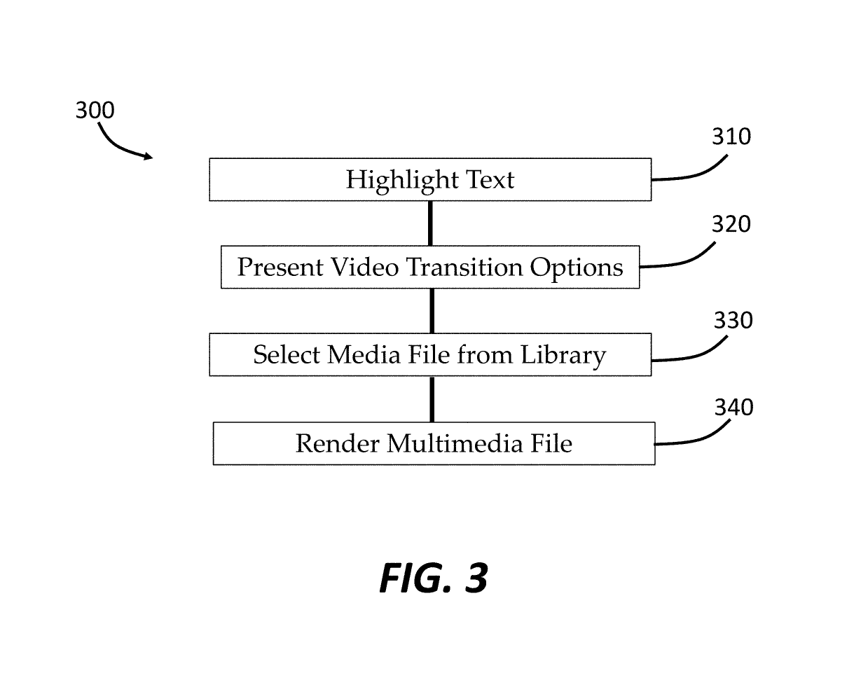

FIG. 3 illustrates a method 300 of automatically pairing a sequence of video clips with user provided timestamps. As video creation has become a daily task for content creators, traditional video editing tools may be burdensome. Creators usually manually insert and trim each video clip, and then manually insert each text box onto the appropriate video clip. The effort that goes into this process can be tedious and time consuming, and the process is usually carried out on a professional editing platform. The method 300 allows a creator to “pin” (link) a video to a user inputted timestamp. As a result, a video clip or series of clips can be automatically inserted, trimmed, and paired with the appropriate article of text, substantially reducing the start-to-finish editing process.

At step 310 of the method 300, a user highlights a word or multiple words within the inputted text, to be used for the video clip on a platform, which can be a user device or a remote server. In response, the platform marks the highlighted text for subsequent processing. At step 320 of the method 300, the platform provides the user with video effects which can be applied to the highlighted text when rendered. At step 330, the platform retrieves the video clip from a library in response to a selection from the user. At step 340, after the user has input timestamps for each article of text, the platform renders the multimedia file incorporating the associated text and the video effects.

Method for Automatically Formatting and Rendering Text with Video

Currently, a growing amount of social videos are viewed silently on a mobile device and it can desirable for video creators to add subtitles and captions to the silent videos to share information with their followers. For example, Facebook and YouTube both allow creators to upload a subtitle file (SRT) to their videos so that the videos can be watched silently. However, there is usually a lack of control over the text formatting, spacing, and/or positioning, which can make the text illegible on a mobile device. In addition, mobile users are often active (e.g., walking or traveling on subway, train, or car), the desired formatting can vary, depending on how many words are being spoken or the color of the video background.

The technology of automatic formatting and rendering of text with video allows creators to customize the formatting of their subtitles and captions. The subtitles and captions can be provided by the user or through an API speech-to-text technology. A creator can control the point size, font, color and positioning of the text, before it is rendered to a multimedia file.

Methods for Automatically Resizing Text Size in Video

As social videos have become primarily text-driven, creators have begun to apply special effects to their text in order to catch the attention of the viewer and apply a unique style to their message. One text effect is “scale-to-fit”. For example, a creator can manually resize a word or sentence so it automatically stretches to the width of a bounding box, which in effect can add more emphasis to a particular word or phrase. However, this effect is usually created on a professional editing platform, which can be costly and inaccessible to many individual video creators. In addition, each text box is typically inserted and stretched manually to the appropriate width, thereby increasing the amount of time for this process.

Automatic resizing in a video can address this problem by automatically stretching a line of text so it fills the bounding box. The text can be inputted by the user in real-time or captured with an API speech-to-text technology. A line with fewer words, or characters, can be stretched to a larger size than a line with a greater amount of words. In effect, creators can convert static text to dynamic text in real-time, and then render the text with video from the backend.

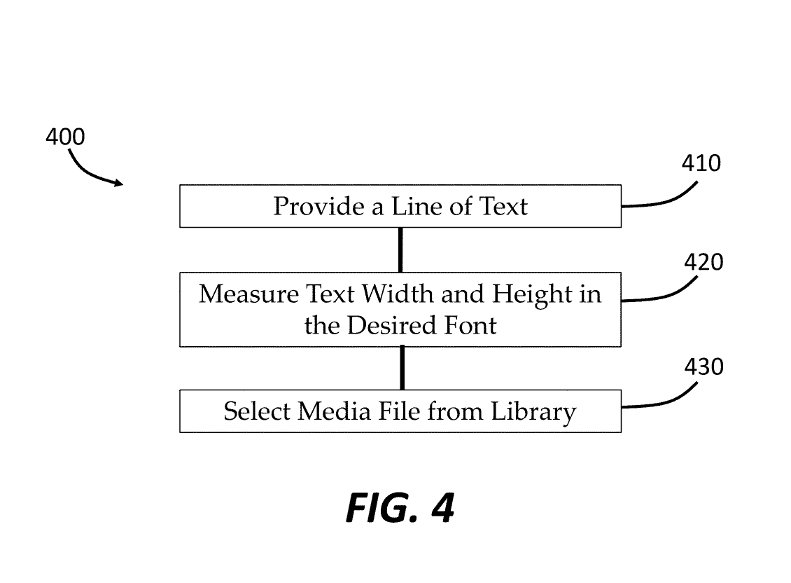

FIG. 4 illustrates a method 400 of automatic resizing of text in videos. At step 410 in the method 400, a line of text is provided by the user to a platform. At step 420 in the method 400, the platform measures the width and height of the text in a font chosen by the user or a default font chosen by the system. At step 430 in the method 400, a scale ratio number is compared to the maximum width and height using the measurements acquired at step 420. This comparison can be calculated by the respective video measurements minus the padding given to each video. This calculation allows each line of text to automatically resize to the width of the window. An example of this technology can be achieved by the following pseudo code:

scale = (canvas_width − canvas_padding) / width_of_text_line_text_
width = width_of_text_line * scale;
text_height = height_of_text_line * scale;
x = (canvas_width − text_width) / 2;
y = (canvas_height − canvas_padding) / 2) + (text_height / 2) drawText
(x, y)

User Interfaces of Interactive Multimedia Creation Tools

Systems and methods described above with reference to FIGS. 1-4 can be configured into user-friendly tools for users to create multimedia files. These tools can provide one or more user interfaces for users to input the media file, the text strings, and the user commands. The interfaces can also allow users to connect to remote servers, which can have greater computing capacity for multimedia creation. FIGS. 5A and 5B show examples of interfaces that can be used in the multimedia creation tools and can perform the methods illustrated in FIGS. 2-4.

FIGS. 5A and 5B show an interface 500 of an interactive multimedia creation tool on a user's mobile device 510. Via the interface 510, a user can access a software service provided by, for example, a remote server. A user can also use the interface 510 to use locally installed multimedia creation tools. The interface 510 allows a user to log into a dedicated interactive multimedia creation tool user account (“User Account”). The User Account can allow a user to access the tool, such as, by signing into an internet website. User Accounts can be associated with third party accounts or inputs that could provide either audio or visual media inputs, such as, but not limited to, iTunes, Youtube, Soundcloud, and Vimeo, among others known to the art.

A user can input the text for their video using the input text tool 520. In this case, a user can describe events (e.g., daily events) using sentences. Each sentence can include a text string, which will be input into the video using user inputted timestamps.

A user can use tool 530 to associate, or “pin,” an individual string of text to a particular video or photo stored on the mobile device. Text selection tool 540 allows a user to select a sentence, or any group of words which have been separated using a hyphen, double space or blank line. Media selection tool 550 allows a user to choose a video or photo to pin to the selected text. Any text that has been pinned to a video or photo can also change in color, as indicated by 560. All following sentences, up until the next colored sentence, can also be pinned to that video or photo. In effect, multiple sentences can be pinned to one video or photo.

After a user has associated the selections of text with their appropriate video or photo, they can be instructed to begin tapping their screen or keyboard 570 in order to insert a timestamp. This process can capture the duration and placement of each string of text 575, and the video or photo 580 to which each string of text is pinned. Each time a user taps their screen, the previous string of text can be removed using an automatic transition, and the next string of text can be inserted. If a video or photo is pinned to a string of text, that video or photo will be inserted with the string of text, replacing whichever photo or video came before. If the duration of a video file is shorter than the length of time it takes for the video's pinned strings of text to be inserted by the user, the video file can automatically repeat, or “loop”, until the next pinned video or photo is inserted. This process can drastically speed up the editing process by letting the user create multiple timestamps using one tap.

FIG. 5C shows an interface 503 of an interactive multimedia creation tool on a user's tablet 513. Via the interface 503, a user can access a software service provided by, for example, a remote server. A user can also use the interface 503 to use locally installed multimedia creation tools. The interface 503 allows a user to log into a dedicated interactive multimedia creation tool user account (“User Account”). The User Account can allow a user to access the tool, such as, by signing into an internet website. User Accounts can be associated with third party accounts or inputs that could provide either audio or visual media inputs, such as, but not limited to, iTunes, Youtube, Soundcloud, and Vimeo, among others known to the art. User Accounts can also be associated with a user's own audio or video inputs 514 (“User Inputs”), such as, but not limited to, audio inputs stored on the device from which the user is accessing the User Account.

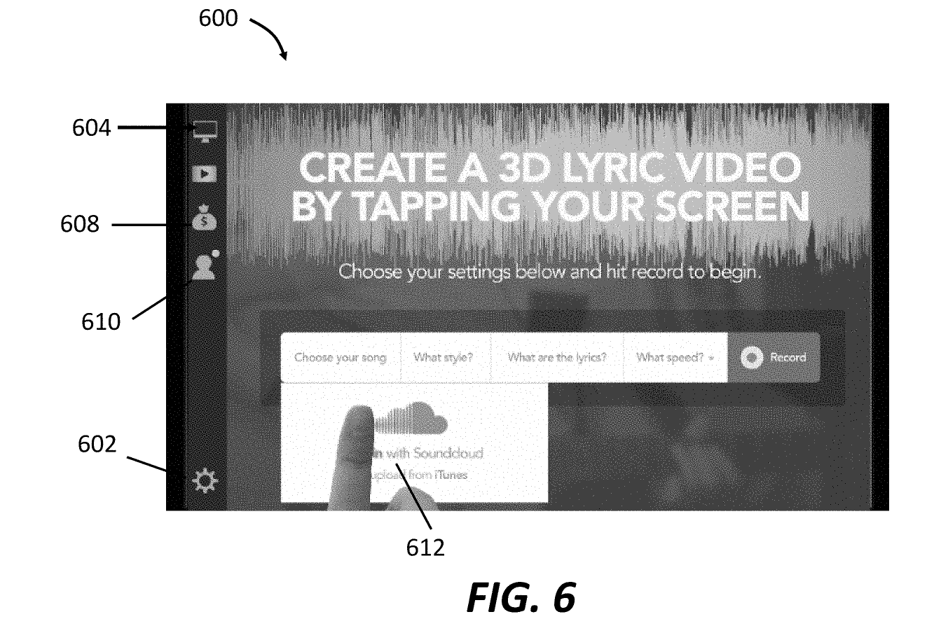

FIG. 6 shows a user interface 600 of an interactive multimedia creation tool including features to facilitate video creation. The interface 600 includes a setting tool 602, which allows the user to set operation parameters of the interactive multimedia creation tool, such as the audio track which will be layered with the video, the text which will be captured by user inputs, the font style, color and effects which will be applied to the video during rendering, the recording speed, among others.

The user can access suggestions from other users via the suggestion tool 610. In this case, each user can provide feedbacks to other users' work, such as lyric videos or captioned videos. These feedbacks may include skills to create a lyric video, or comments on the strength and/or weakness of the video. This can construct a community for users to discuss video creation.

The user can also access input from different sources using the source tool 612. For example, the user can upload the raw media file from his own computer, from a website, or from a recording machine (e.g., an audio recorder or a video recorder). In addition to the tools described above, the interface 600 can further include other tools, such as tools for sharing the generated multimedia file on social media or other websites, tools to access associated third party accounts, tools to access User Inputs, tools to access previously stored creation tools components, tools to request feedback from other creation tool users, or tools to access other similar creation tool capabilities.

The associated third party accounts can be accessed using a number of different technologies known to the art, such as linking to a third-party website using the third-party website API, among others. The User Inputs may be accessed using a number of different technologies known to the art, such as uploading from a local device, or P2P transfer protocols, among others.

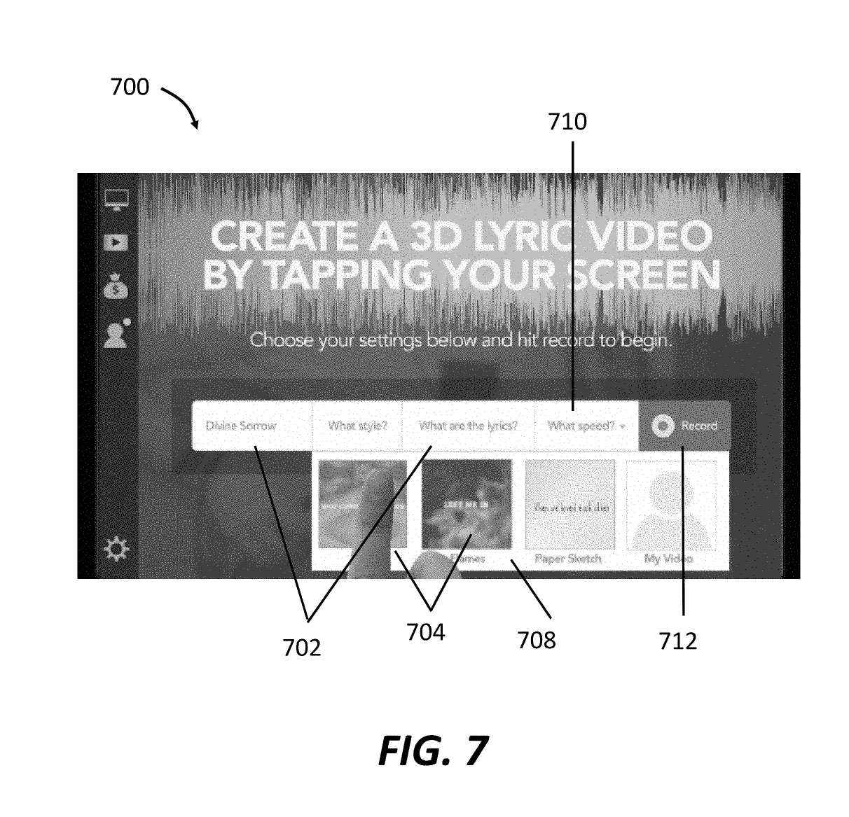

FIG. 7 shows a user interface 700 of an interactive multimedia creation tool including components for adjusting visual effects. The interface 700 includes access to functionality allowing a user to associate visual media with other types of media including, but not limited to, audio recordings and lyrics 702 (each, an alternative media inputs). The visual media creation tool can allow users to generate visual representations of audio recordings 704, such as, but not limited to, a lyric video associated with a song. The visual media creation tool can comprise predetermined settings 708 (settings) for the output of the visual media creation tool (visual media output). The settings may be provided by other users of the visual media creation tool.

The visual media creation tool settings may control the visual effects of the visual media output. In one example, a user of the visual media creation tool can choose a background for the visual media output of clouds, flames, a paper sketch or any other predetermined setting. The visual media output may comprise several different types of backgrounds and visual settings associated with different portions of the output. The visual media creation tool can incorporate information or data from other media sources, such as, but not limited to, lyrics from an audio recording. The information or data from other media sources may be generated by the user or obtained from third party sources.

The interface 700 further includes a speed button 710 for the user to adjust the speed of playing the output media or the playback speed of the input media file. For example, the user can reduce the playback speed of the input media file such that it can be easier for the user to create timestamps more accurately. The interface 700 also includes a record button 712. By tapping the record button, the user can start recording (e.g., creating video files).

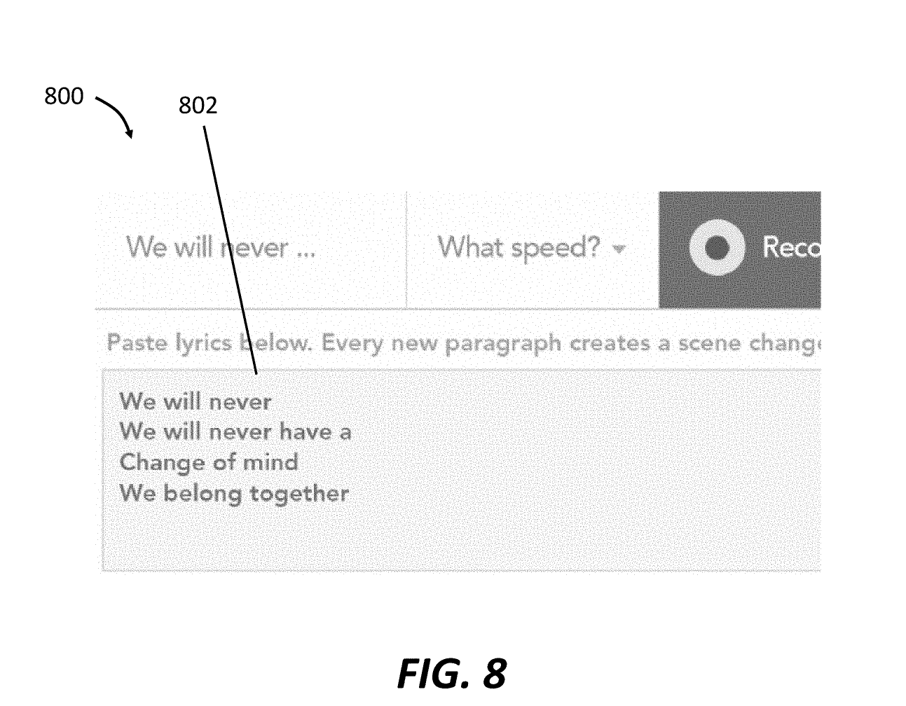

FIG. 8 shows a visual media creation tool component 800 of an interactive multimedia creation tool. The multimedia creation tool can allow a user to segment or reorganize the information or data to align with the visual media output or to align with any alternative media input. In one example, the user can choose to create a space between lyric paragraphs to indicate that the background to the visual media output should change 802. The segmentation or reorganization may incorporate creation tools that are predetermined or provided by third parties or other users of the visual media creation tool such as, but not limited to, automatically inserting a hyphen to represent the animation of a syllable in a lyric video.

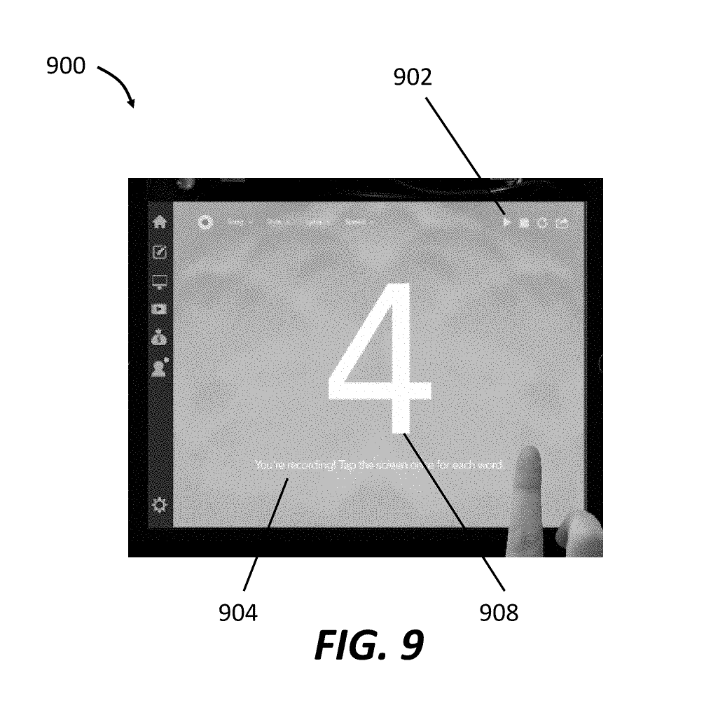

FIG. 9 shows a user interface 900 of an interactive multimedia creation tool including a navigation tool 902. The navigation tool 902 can include several different navigation controls, such as, but not limited to, record, play, stop, pause, or share the visual media output.

The interface 900 can provide various types of notifications 904 to users. For example, interface 900 can notify users of significant moments in the alternative media input, such as the beginning of an audio segment. The interface 900 can also notify users of parameters in the visual media output, such as, but not limited to, the length of the visual media output. The interface 900 can further notify users of the current navigation state of the Visual Media Output, such as, but not limited to, notifying the user that the visual media output is currently playing. The interface 900 as shown in FIG. 9 also includes a countdown indicator 908 to indicate the significance of an event, such as the beginning of a recording.

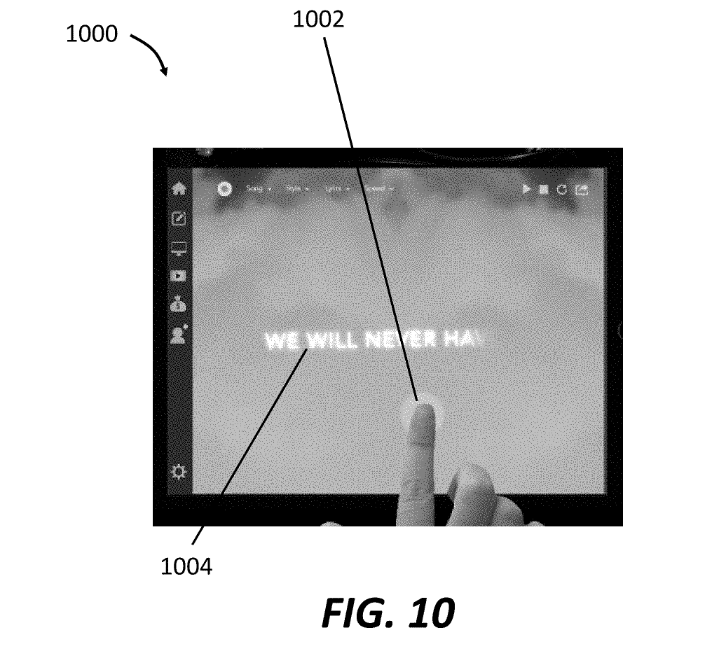

FIG. 10 shows a visual media output 1000 using interactive multimedia creation tools. The output 1000 includes a lyric of a song 1004 in response to a user's tapping 1002 of a key on a keyboard, touch of a responsive touchscreen, click of a mouse, or other input. The visual media creation tool's output generation can be based on the settings selected by the user via the User Interface (e.g., using the setting tool 602). In one example, when an user touches a screen while using the visual media creation tool, a lyric may be generated at the location of the user's touch and can be accompanied by an effect previously selected by the user for the lyric or for the corresponding segment of music. The visual media creation tool can alter outputs based on a number of different factors such as, but not limited to, screen size or operating system.

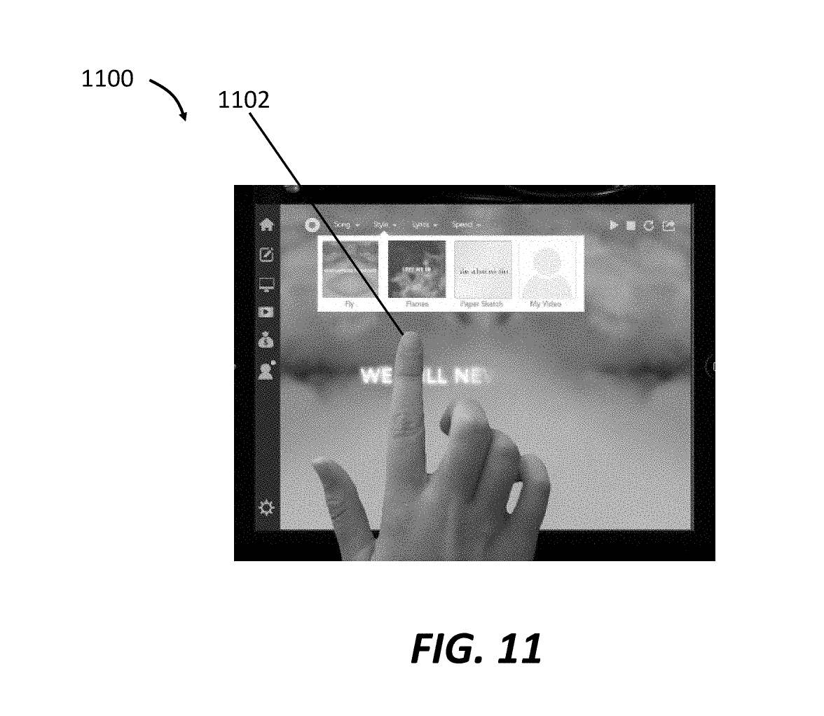

FIG. 11 shows a visual media creation tool component 1100 of an interactive multimedia creation tool for real-time alteration of visual effects. Using the component 1100, outputs can be altered by the user in real time. The alteration includes pausing the Visual Media Output, changing preset settings, or changing the Alternative Media Input, such as, but not limited to, changing the lyrics of a song in response to a tapping 1102 of the user.

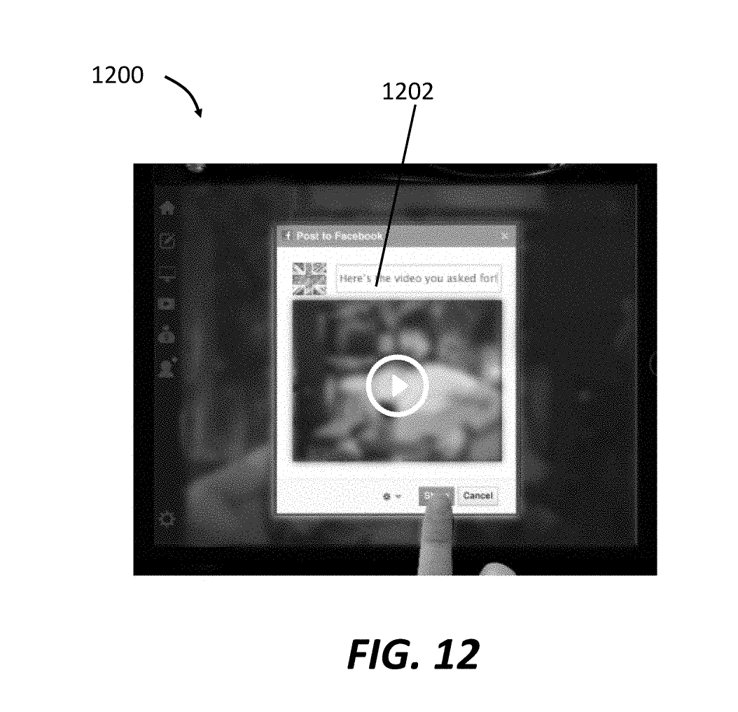

FIG. 12 shows a user interface 1200 for sharing a visual media output using the interactive multimedia creation tool. After a user has finished generating the Visual Media Output, the Visual Media Output can be saved or shared to other users or third parties, such as, but not limited to, via social networking sites and via public media forums 1202.

### CONCLUSION

While only a few embodiments of the present disclosure have been shown and described, it will be obvious to those skilled in the art that many changes and modifications may be made thereunto without departing from the spirit and scope of the present disclosure as described in the following claims. All patent applications and patents, both foreign and domestic, and all other publications referenced herein are incorporated herein in their entireties to the full extent permitted by law.

The methods and systems described herein may be deployed in part or in whole through a machine that executes computer software, program codes, and/or instructions on a processor. The present disclosure may be implemented as a method on the machine, as a system or apparatus as part of or in relation to the machine, or as a computer program product embodied in a computer readable medium executing on one or more of the machines. In embodiments, the processor may be part of a server, cloud server, client, network infrastructure, mobile computing platform, stationary computing platform, or other computing platform. A processor may be any kind of computational or processing device capable of executing program instructions, codes, binary instructions and the like. The processor may be or may include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor, or any machine utilizing one, may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server, cloud server, and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, social networks, and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs, or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements. The methods and systems described herein may be adapted for use with any kind of private, community, or hybrid cloud computing network or cloud computing environment, including those which involve features of software as a service (SaaS), platform as a service (PaaS), and/or infrastructure as a service (IaaS).

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, program codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps associated therewith, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, methods described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

The use of the terms “a” and “an” and “the” and similar referents in the context of describing the disclosure (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above described embodiment, method, and examples, but by all embodiments and methods within the scope and spirit of the disclosure.

All documents referenced herein are hereby incorporated by reference.

1. A system for generating a multimedia file, the system comprising:
a media player;
at least one user input device;
a memory to store processor-executable instructions; and
a processor operably coupled to the media player, the at least one user input device, and the memory, wherein upon execution of the processor-executable instructions, the processor:
receives a media file having a time structure;
receives a sequence of text strings;
creates a plurality of timestamps within the time structure of the media file in response to user commands entered via the at least one input device while playing the media file on the media player;
saves the plurality of timestamps within the memory;
associates each text string in the sequence of text strings with a corresponding timestamp in the plurality of timestamps; and
renders the multimedia file based at least in part on the media file, the plurality of timestamps, and the sequence of text strings.

2. The system of claim 1, wherein the at least one user input device comprises a keyboard and the user commands comprises hitting of a key on the keyboard.

3. The system of claim 1, wherein the media file comprises an audio file and the sequence of text strings comprises at least a portion of a transcript of the audio file.

4. The system of claim 1, wherein the media file comprises a video file and the sequence of text strings comprises at least a portion of a subtitle of the video file.

5. The system of claim 1, wherein adjacent text strings in the sequence of text strings are separated by a separator character.

6. The system of claim 1, wherein upon execution of the processor-executable instructions, the processor associates each text string in the sequence of text strings with the corresponding timestamp based at least in part on a location of each text string in the sequence of text strings.

7. The system of claim 1, wherein upon execution of the processor-executable instructions, the processor publishes the multimedia file on a social media site.

8. The system of claim 1, wherein upon execution of the processor-executable instructions, the processor changes a speed of playing the media file so as to facilitate a user to input the user commands from the at least one user input device.

9. The system of claim 1, further comprising a display, operably coupled to the processor, to display the sequence of text strings and, upon execution of the processor-executable instructions, the processor dynamically changes a font size of the sequence of text strings displayed on the display based at least in part on a size of the display.

10. A method for generating a multimedia file, the method comprising:
receiving a media file having a time structure;
creating a plurality of timestamps within the time structure of the media file based on a plurality of user commands provided by a user with at least one input device while playing the media file on a media player;
saving the plurality of timestamps within a memory;
receiving a sequence of text strings;
associating each text string in the sequence of text strings with a corresponding timestamp in the plurality of timestamps; and
rendering the multimedia file based at least in part on the media file, the plurality of timestamps, and the sequence of text strings.

11. The method of claim 10, wherein creating the plurality of timestamps comprises creating the plurality of timestamps in response to at least one of touches on a touch screen or hitting of a key on a keyboard by a user.

12. The method of claim 10, wherein receiving the media file comprises receiving an audio file and receiving the sequence of text strings comprises receiving at least a portion of a transcript of the audio file.

13. The method of claim 10, wherein receiving the media file comprises receiving a video file and receiving the sequence of text strings comprises receiving at least a portion of a subtitle of the video file.

14. The method of claim 10, wherein receiving the sequence of text strings comprises at least one of receiving the sequence of text strings via the at least one input device, receiving the sequence of text strings from the memory, or receiving the sequence of text strings separated by separator characters.

15. The method of claim 10, wherein associating each text string with the corresponding timestamp comprises determining the corresponding timestamp based at least in part on a location of each text string in the sequence of text strings.

16. The method of claim 10, further comprising:
publishing the multimedia file on a social media site.

17. The method of claim 10, further comprising:
playing the media file; and
changing a play speed of the media file so as to facilitate input of an input command in the plurality of user commands via the at least one user input device.

18. The method of claim 10, wherein rendering the multimedia file comprises:
displaying the sequence of text strings overlaid on the media file.

19. The method of claim 18, wherein rendering the multimedia file comprises:
displaying the multimedia file on a display; and
dynamically changing a font size of the text strings displayed on the display based at least in part on a size of the display.

20. A system for generating a multimedia file, the system comprising:
a touch screen;
a memory to store processor-executable instructions; and
a processor operably coupled to the touch screen and the memory, wherein upon execution of the processor-executable instructions, the processor:
receives a music file including a video manifestation and an audio file, the music file having a time structure;
creates a plurality of timestamps within the time structure of the music file in response to touches on the touch screen from a user;
saves the plurality of timestamps within the memory;
receives a sequence of text strings including a lyric of the music file, adjacent text strings in the sequence of text strings being separated by a separator character;
associates each text string in the sequence of text strings with a corresponding timestamp in the plurality of timestamps based at least in part on a location of each text string in the plurality of text strings;
renders the multimedia file based at least in part on the music file, the plurality of timestamps, and the sequence of text strings; and
displays the multimedia file with the sequence of text strings overlaid on the video manifestation of the music file and synchronized with the audio file of the music file.
